(19) United States
(12) Patent Application Publication
(10) Pub. No.: US 2016/0165286 A1
(43) Pub. Date: Jun. 9, 2016

(54) METHOD, APPARATUS AND SYSTEM FOR DISTRIBUTION OF AUXILIARY ADVERTISEMENTS

(71) Applicants: Zhigang ZHANG, Beijing (CN); Shiyun TAO, Xicheng District, Beijing (CN); Yangfeng ZHANG, Chaoyang District, Beijing (CN)

(72) Inventors: Zhigang ZHANG, Beijing (CN); Shiyun TAO, Beijing (CN); Yangfeng ZHANG, Beijing (CN)

(21) Appl. No.: 14/908,305

(22) PCT Filed: Aug. 7, 2013
(86) PCT No.: PCT/CN2013/080999

§ 371 Date: Jan. 28, 2016

(51) Int. Cl. H04N 21/2668; H04N 21/41; H04N 21/475; H04N 21/258; H04N 21/45; H04N 21/81; H04N 21/43

(52) U.S. Cl. CPC H04N 21/2668; H04N 21/812; H04N 21/4122; H04N 21/4307; H04N 21/25883; H04N 21/4532; H04N 21/4755; H04N 21/4126

(57) ABSTRACT

A method, apparatus and system are provided for distributing auxiliary advertisements which include receiving profile information, searching a database for auxiliary advertisements associated with the received profile information and communicating auxiliary advertisements associated with the received profile information to a display device for presentation on at least a portion of a screen of the display device. In one instance, a primary display device presents primary advertisements and a secondary screen device presents associated, targeted auxiliary advertisement(s) at a time concurrent with or relative to the presentation of the primary advertisement; an auxiliary advertisement to be presented to an identified viewer/audience being selected by matching metadata associated with the auxiliary advertisement to known characteristics of the identified viewer/audience.

### BACKGROUND OF THE INVENTION

1. Technical Field

The present principles relate generally to a system and method for advertisement distribution and more particularly to a system and method for delivering multiple correlated auxiliary advertisements on multiple screens.

2. Related Art

With the wide spread adoption of many kinds of portable devices such as mobile phones and tablets, which are also considered second screen devices while used in conjunction with the use of a primary display such as a television set, viewers are increasingly watching content on their portable devices, resulting in more and more viewer attention directed away from television advertisements and thus decreasing the effectiveness of television advertising.

Additionally, television viewers are beginning to use TV check-in applications on the secondary devices to let others know which television channels and programming they are watching. Such viewers also chat with their acquaintances regarding the programming content as they are watching a program. A main revenue sources for TV check-in application providers comes from the distribution of advertisements on their application's interface. Nevertheless, how to offer relevant advertisements to users remains an open issue for these providers.

### SUMMARY OF THE INVENTION

Embodiments of the present invention address these and other deficiencies of the prior art by providing a method, apparatus and system for distribution of auxiliary advertisements.

In one embodiment of the present invention, a method for distribution of auxiliary advertisements includes receiving profile information, searching a database for auxiliary advertisements associated with the received profile information and communicating auxiliary advertisements associated with the received profile information to a display device for presentation on at least a portion of a screen of the display device. In an alternate embodiment of the present invention, the method can further include receiving information regarding when a primary advertisement associated with at least one auxiliary advertisement is to be presented on a screen of a primary display device and communicating an associated auxiliary advertisement for presentation on a screen of the secondary display device at a time concurrent with or relative to the presentation of the primary advertisement on the screen of the primary display device.

In an alternate embodiment of the present invention, an apparatus for distributing auxiliary advertisements includes a memory for storing program routines, content and data and a processor for executing the program routines. The apparatus of the invention is configured to receive profile information, search a database for auxiliary advertisements associated with the received profile information and communicate auxiliary advertisements associated with the received profile information to a display device for presentation on at least a portion of a screen of the display device. The apparatus of the invention can be further configured to receive information regarding when a primary advertisement associated with at least one auxiliary advertisement is to be presented on a screen of a primary display device and communicate an associated auxiliary advertisement for presentation on a screen of the secondary display device at a time concurrent with or relative to the presentation of the primary advertisement on the screen of the primary display device.

In an alternate embodiment of the present invention, a system for distributing auxiliary advertisements includes a database for storing at least auxiliary advertisements, a primary display device for displaying programming content and primary advertisements, a secondary display device for displaying auxiliary advertisements and an apparatus configure to receive profile information, search the database for auxiliary advertisements associated with the received profile information, and communicate auxiliary advertisements associated with the received profile information to the secondary display device for presentation on at least a portion of a screen of the secondary display device. The apparatus of the system can be further configured to receive information regarding when a primary advertisement associated with at least one auxiliary advertisement is to be presented on a screen of a primary display device and communicate an associated auxiliary advertisement for presentation on a screen of the secondary display device at a time concurrent with or relative to the presentation of the primary advertisement on the screen of the primary display device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for the distribution of auxiliary advertisements in accordance with an embodiment of the present invention;

FIG. 2 depicts a high level block diagram of a check-in server able to be implemented in the system of FIG. 1 in accordance with an embodiment of the present invention; and

FIG. 3 depicts a flow diagram of a method for the distribution of auxiliary advertisements in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for the distribution of auxiliary advertisements. Although the present invention will be described primarily within the context of television programming and advertising, the specific embodiments of the present invention should not be treated as limiting the scope of the invention. It will be appreciated by those skilled in the art and informed by the teachings of the present invention that the concepts of the present invention can be advantageously applied to other types of programming content and advertising. For example, the concepts of the present invention can be applied to internet protocol programming and advertising over the web and internet.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Furthermore, because some of the constituent system components and methods depicted in the accompanying drawings can be implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Embodiments of the present invention include the delivery of auxiliary targeted advertisements to an auxiliary screen device, such as, for example, a mobile phone, a tablet, a laptop, etc., of a TV viewer, in various embodiments, during delivery of a video content and advertising which is displayed on the TV viewer's primary screen device. In one embodiment of the present invention, the auxiliary advertisement delivery is performed by matching a TV viewers' profile information with characteristics of a targeted audience for which an auxiliary advertisement is intended, such characteristics used to identify auxiliary advertisements for storage. Embodiments of the present invention enable different auxiliary advertisements to be presented to viewers having different profile characteristics even as those viewers are watching a same primary program or advertising content on a primary display.

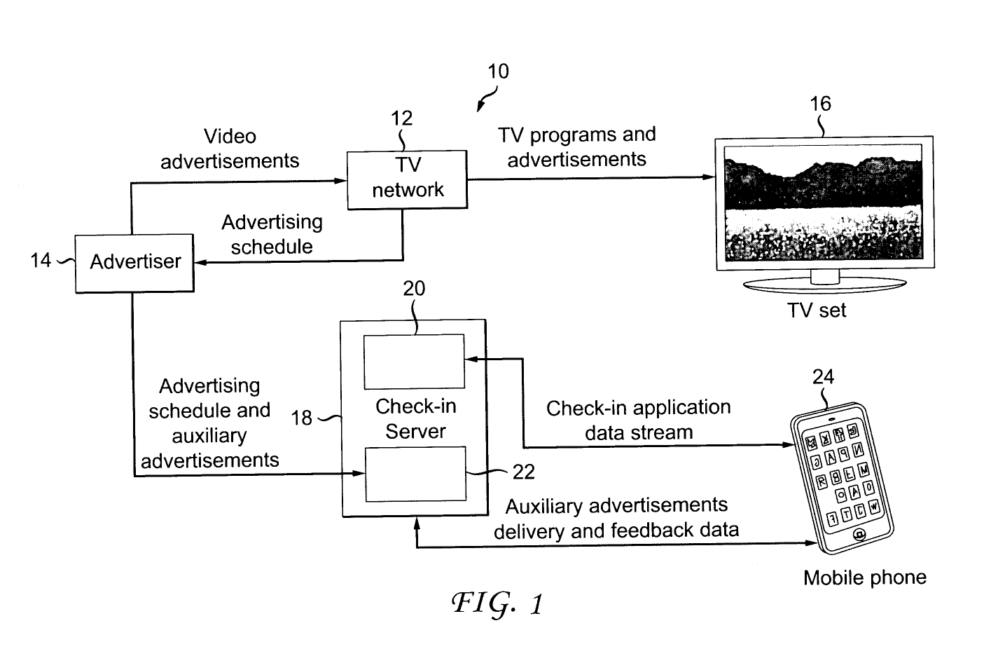

FIG. 1 depicts a high level block diagram of a system 10 for the distribution of auxiliary advertisements in accordance with an embodiment of the present invention. In accordance with one embodiment of the present invention a check-in server of the present invention receives information regarding a profile of a user/television viewer, searches an auxiliary advertisement database for auxiliary advertisements associated with the user profile and communicates the associated auxiliary advertisements to a second display device for display to the user. In the embodiment of FIG. 1, a TV network 12 provides an advertising schedule to an advertiser 14 who provides advertisements to the TV Network 12. The TV network 12 transmits TV programs including primary advertisements to a user's primary display device 16, illustratively a television set. That is, the TV network 12 transmits the broadcast programs, including advertisements, over a broadcasting infrastructure to the user's primary display 16 for presentation on the display 16.

The system 10 of FIG. 1 further includes a check-in server 18. The check-in server 18 of FIG. 1 is in two way communication with a user's secondary or auxiliary display device, illustratively a mobile phone 24 and is in communication with the Advertiser 14. The Advertiser 14 communicates at least information regarding for which user(s) or targeted audiences auxiliary advertisements are intended. In the embodiment of FIG. 1, the check-in server 18 includes an application provider 20, and an auxiliary advertisement provider 22. In various embodiments of the present invention, the two way communications of the embodiment of FIG. 1 can be implemented using any known wired or wireless communication protocols. Examples of such communication protocols include WiFi connectivity which can include 802.11b and/or 802.11g wireless protocols, cellular communication connections at higher frequencies, and the like. Those of skill in the art will appreciate that these connections, interfaces and communication protocols can be changed or modified without departing from the intended scope of the present principles.

In the embodiment of FIG. 1, the Advertiser 14 not only provides primary advertisements for TV networks to broadcast and to be displayed on a primary display device, illustratively the TV set 16 of FIG. 1, but also provides auxiliary advertisements, which are related to the products being advertised in the primary advertisement but are more targeted and are intended to be displayed to specific audiences, for example based on user characteristics, demographics, etc. comprising a user profile.

In the embodiment of FIG. 1, while watching a TV program on, for example, the TV set 16, a user/viewer uses a TV check-in application on a secondary screen device, such as a mobile phone, tablet or other media display device (illustratively a mobile phone 24), to interact with his/her friends regarding a TV program/channel being presented on the primary display 16. In the embodiment of FIG. 1, the user/viewer is prompted by the TV check-in application to input profile information such as birthday, living area, age, and any or all types of preferences or personal information that can be used to associate auxiliary advertisements with a user/viewer for accomplishing targeted advertising in accordance with the present invention. That is, the check-in server 18 of FIG. 1 uses such profile information to associate auxiliary advertisements with the viewer. More specifically, auxiliary advertisements can include information, such as metadata, identifying characteristics of at least one of a target audience and a viewer for which a specific advertisement(s) is intended. The check-in server 18 can then use the information to associate specific auxiliary advertisements that are intended for the user of the second screen device identified by the check-in application and communicate associated auxiliary advertisements to a second screen device and specifically the mobile phone 24 in the embodiment of FIG. 1. More specifically, once the auxiliary advertisement or advertisements intended for the user identified by the profile information entered using the check-in application are identified, such advertisements can be communicated to the identified user's second screen device (e.g., the mobile phone 24 in the embodiment of FIG. 1) for display on at least a portion of the screen of the second screen device.

It should be noted that the terms, secondary display device, second screen device, second display device, auxiliary display and the like are used interchangeably throughout the teachings herein and are intended to refer to a display or screen on which auxiliary advertisements can be displayed in accordance with the various embodiments of the present invention. Although in the embodiment of FIG. 1 the second display device 24 is depicted as a separate component from the primary display device 16, in alternate embodiments of the present invention, the second display device 16 can comprise a dedicated portion of the primary display device 16 intended for displaying auxiliary advertisements in accordance with the embodiments of the present invention.

In the embodiment of FIG. 1, the check-in server 18 receives auxiliary advertisements from the Advertiser 14. In such an embodiment in which auxiliary advertisements are stored in a memory of the check-in server 18, upon identification of an auxiliary advertisement that is intended for an identified user of the check-in application, the check-in server 18 communicates the identified auxiliary advertisement to the second display device of the user for display on at least a portion of the second display device. That is, in various embodiments of the present invention, a second display device is configured to display received auxiliary advertisements on a designated portion or portions or an entire screen of the second display device.

In alternate embodiments of the present invention, auxiliary advertisements are stored in another storage device or memory. In such embodiments of the present invention in which auxiliary advertisements are not stored in a memory of the check-in server 18 but in another storage device or memory, the check-in server 18 uses information received regarding the stored auxiliary advertisements (i.e., metadata) to determine for what type of audience an auxiliary advertisement is intended and upon identification of an auxiliary advertisement that is intended for an identified user of the check-in application, the check-in server 18 communicates a request to the storage device or memory in which the auxiliary advertisements are stored to communicate the identified auxiliary advertisement to the second display device of the user for presentation.

As described above, in the embodiment of FIG. 1, the check-in server 18 includes both an application provider 20 and an auxiliary advertisement provider 22. The application provider 20 of the check-in server 18 of FIG. 1 provides check-in application content, such as user profile information and related information for television programs that a user reviews and enables viewers to chat with each other. The auxiliary advertisement provider 22 receives advertising schedule information and auxiliary advertisements and communicates the corresponding auxiliary advertisement, which correlates with at least one user profile, to a second display device of the user.

Although in the embodiment of FIG. 1 it is described that user profile information is collected using a TV check-in application, in alternate embodiments of the present invention user profile information can be learned from a user's second display device or primary display device by collecting any user profile information stored or entered thereon. In yet alternate embodiments of the present invention, user profile information can be communicated to a check-in server of the present invention from a TV network or Advertiser to which a user has previously communicated such user information.

In addition, although in FIG. 1, the check-in server 18 is depicted as comprising a separate component, in alternate embodiments of the present invention a check-in server or the check-in server functionality can comprise an integrated component of or functionality in at least one of a primary display device, such as the TV set 16 of FIG. 1, a controller of the primary display device, such as a set-top box (not shown) a secondary display device, such as the mobile phone 24 of FIG. 1, or any other mobile communications device.

In an alternate embodiment of the present invention, information regarding the air time schedule for advertisements to be presented along with the primary program to be displayed on the primary display 16 is also communicated to the check-in server 18. That is, in one embodiment of the present invention, the TV network 12 receives video advertisements from various advertisers and provides advertisers 14 with a time schedule describing when the advertisements will be broadcasted. The advertisers 14 can then provide such information to the check-in server 18, for example, along with the auxiliary advertisements. In such embodiments of the present invention, the check-in server can use the air time information of the primary advertisements to communicate auxiliary advertisements associated with the primary advertisements that have been selected for presentation at a time concurrent with or relative to the presentation of the relative primary advertisement. In such embodiment of the present invention, the TV check-in application informs the check-in server 18 of the TV channel and program being presented on the primary display 16.

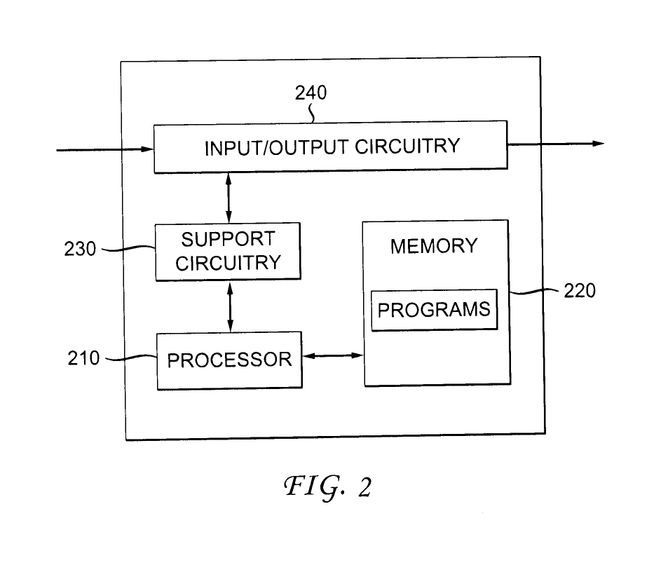

FIG. 2 depicts a high level block diagram of a check-in server 18 able to be implemented in the system of FIG. 1 in accordance with an embodiment of the present invention. The check-in server of FIG. 2 comprises a processor 210 as well as a memory 220 for storing control programs, instructions, software, video content, advertising content and the like. The processor 210 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry that cooperates with the processor 210 to perform various steps. The check-in server 18 also contains input-output circuitry 240 that forms an interface between the various respective functional elements communicating with the check-in server 18. As noted throughout this disclosure, the memory 220 can be a hard disk storage device, a static RAM, a DRAM, ROM, etc., or combinations of the same.

Although the check-in server 18 of FIG. 2 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

The following example of an advertisement for an Audi A8 automobile will be used to describe embodiments of the present invention for the distribution of auxiliary advertisements.

A TV advertisement for an Audi A8, which is a full-size, luxury sedan, is displayed on a primary display screen, for example a TV set.

For a TV viewer “Bill” at age 30 who is watching the advertisement for the Audi A8 on the primary display screen, a specific auxiliary advertisement, highlighting the Audi's sport feature, emerges on a sidebar on the screen of his second display device, for example a mobile phone. An exemplary text of the specific auxiliary advertisement can include the following:
For a more sport-oriented look, the Audio A8 Sport Package includes impressive 20 inch, 5-segment spoke wheels with summer performance tires, which help improve handling and driving dynamics. Audi's adaptive air sport suspension with Sport Rear Differential provides state-of the-art handling creating true sports car handling. Inside, you'll enjoy 22-way driver and passenger sport comfort seats with lumbar support, ventilated seats and six-way massage functions. The seats are wrapped in Valcona leather with a sport stitched diamond pattern.

For another viewer “George” at age 50 who is watching the same TV advertisement on a primary display screen, another auxiliary advertisement, highlighting the Audi's convenience aspect, emerges as a sidebar of a screen of his tablet. The specific auxiliary advertisement can include the following:
The Audi A8 Convenience Package includes many thoughtful features to make your driving experience more convenient. Power door close assist provides enhanced comfort and convenience when entering and exiting the vehicle. The power trunk feature allows you to open and close the trunk with the push of a button while the Audi parking system plus provides front and rear ultrasonic parking sensors that measure the distance to the nearest object and audibly warn you when the distance becomes unsafe. The package also offers keyless entry, allowing you to lock or unlock and start your vehicle without removing the key from a pocket or purse.

For yet another TV viewer “Frank”, who lives in a very cold area such as Calgary, Canada, and is watching the same TV advertisement on the Audi A8 on a cold winter evening, another particular auxiliary advertisement, highlighting the Audi's improved driving experience during cold weather, emerges on his mobile phone screen. An exemplary text of the specific auxiliary advertisement can include the following:
In addition to the standard front heated seats, the Audi A8 Cold Weather Package provides rear occupants their ideal level of comfort via the multilevel seat heating system, which is designed to heat the entire surface of the seat; warming is initiated with a convenient button. Also included is a heated, multifunction steering wheel with shift paddles, which provides easy access to volume control, radio station and CD track selection, navigation voice prompts and telephone dialing, while shift paddles allow for quick gear changes. The ski sack with rear seat pass-through optimizes the storage space and usability of the already roomy A8 interior.

In the first example described above, Bill, a 30 year old man, is presented an auxiliary advertisement regarding the sport features of the Audi A8 on a sidebar of the screen of his mobile phone because he used a TV check-in application to indicate that he is viewing the channel broadcasting the primary Audi advertisement. A check-in server, such as the check-in server 18 of FIG. 1, retrieved information from Bill's profile entered by Bill using the TV check-in application. The check-in server 18 searched an auxiliary advertisement database and identified an auxiliary advertisement, in this case the auxiliary advertisement regarding sport features of the Audi A8, that matched Bill's user profile. In this embodiment of the present invention, the auxiliary advertisement regarding the sport features of the Audi A8 was identified as being intended for a target audience including Bill's age group. The auxiliary advertisement regarding the sport features of the Audi A8 was then communicated to a sidebar of the screen of Bill's mobile phone which was previously configured for displaying auxiliary advertisements.

In the second example provided above George, a middle-aged man, is presented an auxiliary advertisement on the convenience features of the Audi A8 on a sidebar of a screen of his tablet because he used a TV check-in application to indicate that he is viewing the channel broadcasting the primary Audi advertisement. A check-in server, such as the check-in server 18 of FIG. 1, retrieved information from George's profile entered by George using the TV check-in application. The check-in server 18 searched an auxiliary advertisement database and identified an auxiliary advertisement, in this case the auxiliary advertisement regarding convenience features of the Audi A8, that matched George's user profile. In this embodiment of the present invention, the auxiliary advertisement regarding the convenience features of the Audi A8 was identified as being intended for a target audience including George's age group. The auxiliary advertisement regarding the convenience features of the Audi A8 was then communicated to a sidebar of the screen of George's tablet which was previously configured for displaying auxiliary advertisements.

In the last example presented above, Frank, a man living in a very cold area, is presented an auxiliary advertisement on the cold weather features of the Audi A8 on a screen of his mobile phone because he used a TV check-in application to indicate that he is viewing the channel broadcasting the primary Audi advertisement. A check-in server, such as the check-in server 18 of FIG. 1, retrieved information from Frank's profile entered by Frank using the TV check-in application. The check-in server 18 searched an auxiliary advertisement database and identified an auxiliary advertisement, in this case the auxiliary advertisement regarding cold weather features of the Audi A8, that matched Frank's user profile. In this embodiment of the present invention, the auxiliary advertisement regarding the cold weather features of the Audi A8 was identified as being intended for a target audience including Frank's geographic location. The auxiliary advertisement regarding the cold weather features of the Audi A8 was then communicated to a screen of Frank's mobile phone.

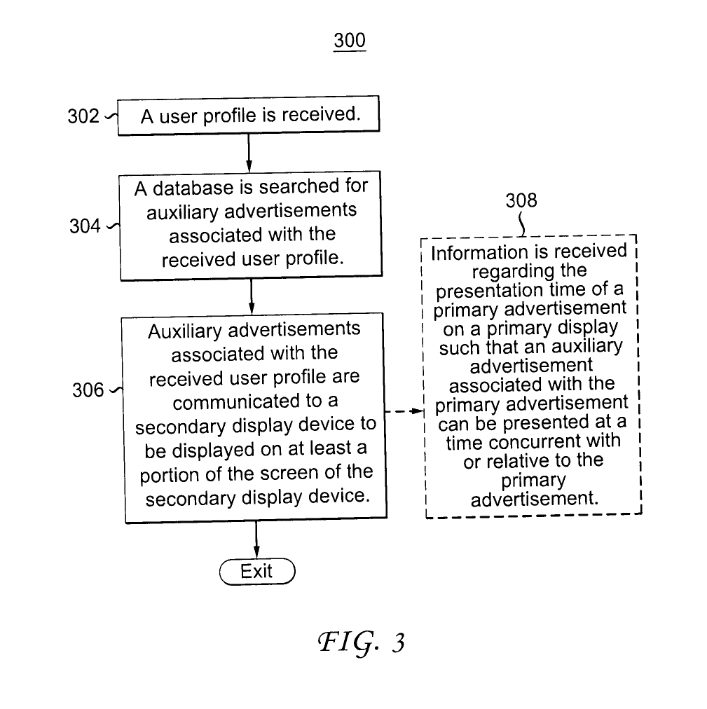

FIG. 3 depicts a flow diagram of a method for the distribution of auxiliary advertisements in accordance with an embodiment of the present invention. The method 300 of FIG. 3 begins at step 302 during which a user profile is received. For example, in one embodiment of the present invention, a user implements a check-in application, such as a TV check-in application, on, for example a second screen device, to enter user profile information, which is then communicated to a check-in server of the present invention. As described above, in alternate embodiments of the present invention, user profile information can be received from alternate sources such as a network provider, advertiser or a user device, such as a second display device. The method 300 then proceeds to step 304.

At step 304, a database is searched for auxiliary advertisements associated with the received user profile. For example and as described above, in one embodiment of the present invention, auxiliary advertisements can be identified using metadata used to identify a target audience or user for which an auxiliary advertisement is intended. The method 300 then proceeds to step 306.

At step 306, auxiliary advertisements associated with the received user profile are communicated to a secondary display device to be displayed on at least a portion of the screen of the secondary display device. The method 300 can then be exited.

The method 300 can further include optional step 308 during which information can be received regarding the presentation time of a primary advertisement on a primary display such that an auxiliary advertisement associated with the primary advertisement can be presented at a time concurrent with or relative to the primary advertisement if the associated auxiliary advertisement is selected for presentation.

In an alternate embodiment of the present invention, the check-in server of the present invention stores the advertising schedule and auxiliary advertisements, associated with a TV advertisement, as soon as they are received from an advertiser. When a time for the broadcasting of a TV program and a primary advertisement is near, the check-in server retrieves a listing of users that are currently viewing a TV channel in which the TV program and primary advertisement will be broadcasted. Such information can be retrieved from the information entered into the check-in application. The check-in server of the present invention then searches a database having the auxiliary advertisements stored thereon to attempt to locate stored auxiliary advertisements that have targeted viewer/audience characteristics that coincide or match or relate to the profile information, such as birthday, geographic location, etc., of the identified check-in users. The check-in server of the present invention can then divide the users and associated/related auxiliary advertisements into groups based on which auxiliary advertisements are related to which users.

Once divided accordingly, an auxiliary advertisement highly targeted to the user's profile and interests will be pushed or communicated to a user's second screen device for presentation on at least a portion of the user's second screen device at a time concurrent with or relative to the presentation of the primary TV advertisement.

In an embodiment in which a broadcasting/air time schedule for a particular primary advertisement is not provided, the broadcasting/air time for the particular primary advertisement can be obtained by the following two methods. In a first method, a unique watermark can be embedded into the primary advertisement, capture the TV program containing the primary advertisement and attempt to extract the watermark using, for example the TV check-in application on the second screen device. The extracted watermark can then be communicated to the check-in server having the watermark associated primary advertisement information. In a second method, a digital fingerprint is extracted from the primary advertisement beforehand, the fingerprint is compared with fingerprints extracted from all broadcasting TV advertisements at real-time at the check-in server. If a match is found, then it can be deduced that the particular primary TV advertisement is currently being broadcasted.

Having described various embodiments for a method, apparatus and system for distribution of auxiliary advertisements (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for distribution of auxiliary advertisements, comprising:
receiving profile information;
searching a database for auxiliary advertisements associated with the received profile information; and
communicating auxiliary advertisements associated with the received profile information to a display device for presentation on at least a portion of a screen of the display device.

2. The method of claim 1, comprising:
receiving information regarding when a primary advertisement associated with at least one auxiliary advertisement is to be presented on a primary display device.

3. The method of claim 2, comprising:
presenting an auxiliary advertisement communicated for presentation on a screen of a secondary display device at a time concurrent with or relative to the presentation of the associated primary advertisement on the primary display device.

4. The method of claim 1, comprising:
receiving information regarding at least one of a channel and a program being presented on a primary display device.

5. The method of claim 4, comprising:
presenting an auxiliary advertisement associated with the program being presented on the primary display device at a time concurrent with or relative to the program being presented on the primary display device.

6. The method of claim 1, wherein an auxiliary advertisement includes metadata identifying characteristics of at least one of a target audience and a viewer to whom the auxiliary advertisement is intended to be presented.

7. The method of claim 1, wherein the display device comprises a secondary display device and program content and primary advertisements are presented on a primary display device.

8. The method of claim 1, comprising:
receiving auxiliary advertisements; and
storing said auxiliary advertisements.

9. The method of claim 1, wherein said profile information is received from at least one of a check-in application receiving viewer inputs, an advertiser, a television network, and a display device.

10. The method of claim 1, wherein said profile information comprises characteristic information of an intended viewer of at least one auxiliary advertisement.

11. The method of claim 1, comprising grouping auxiliary advertisements via profile characteristics for communication to different display devices.

12. An apparatus for distributing auxiliary advertisements, comprising:
a memory for storing program routines, content and data; and
a processor for executing said program routines;
said apparatus configured to:
receive profile information;
search a database for auxiliary advertisements associated with the received profile information; and
communicate auxiliary advertisements associated with the received profile information to a display device for presentation on at least a portion of a screen of the display device.

13. The apparatus of claim 12, comprising:
an application provider for receiving the profile information; and
an auxiliary advertisement provider for searching a database for auxiliary advertisements associated with the received profile information and communicating auxiliary advertisements associated with the received profile information to a display device for presentation on at least a portion of a screen of the display device.

14. The apparatus of claim 12, wherein said apparatus comprises at least a portion of at least one of a set-top box, a display device and a mobile communications device.

15. The apparatus of claim 12, wherein said apparatus is further configure to:
receive information regarding when a primary advertisement associated with at least one auxiliary advertisement is to be presented on a screen of a primary display device; and
communicate an associated auxiliary advertisement for presentation on a screen of the secondary display device at a time concurrent with or relative to the presentation of the primary advertisement on the screen of the primary display device.

16. A system for distributing auxiliary advertisements, comprising:
a database for storing at least auxiliary advertisements;
a primary display device for displaying programming content and primary advertisements;
a secondary display device for displaying auxiliary advertisements; and
an apparatus configure to:
receive profile information;
search the database for auxiliary advertisements associated with the received profile information; and
communicate auxiliary advertisements associated with the received profile information to the secondary display device for presentation on at least a portion of a screen of the secondary display device.

17. The system of claim 16, wherein said secondary display device comprises a check-in application for enabling a user to enter said profile information.

18. The system of claim 17, wherein said secondary device provides, to the apparatus, information regarding at least one of a channel and a program being presented on the primary display device.

19. The system of claim 16, wherein said apparatus is further configured to:
receive information regarding when a primary advertisement associated with at least one auxiliary advertisement is to be presented on a screen of the primary display device; and
communicate an associated auxiliary advertisement for presentation on a screen of the secondary display device at a time concurrent with or relative to the presentation of the primary advertisement on the screen of the primary display device.
